(19) United States
(12) Patent Application Publication
(10) Pub. No.: US 2022/0369575 A1
(43) Pub. Date: Nov. 24, 2022

(54) ONLINE VORTEX ELEMENT EMITTER FOR IRRIGATION

(71) Applicant: DLHBOWLES, INC., CANTON, OH (US)

(72) Inventors: Reza Ronaghian, Canton, OH (US); Benjamin D. Hasday, Canton, OH (US); Gregory A. Russell, Canton, OH (US); Shridhar Gopalan, Canton, OH (US); Christopher F. South, Canton, OH (US)

(21) Appl. No.: 17/880,471

(22) Filed: Aug. 3, 2022

Related U.S. Application Data
(63) Continuation-in-part of application No. 17/402,868, filed on Aug. 16, 2021.
Application No. 17/402,868 is a continuation of application No. 16/001,432, filed on Jun. 6, 2018, now Pat. No. 11,116,151.
(60) Provisional application No. 62/515,973, filed on Jun. 6, 2017.
(60) Provisional application No. 63/228,664, filed on Aug. 3, 2021.

(51) Int. Cl. A01G 25/02

(52) U.S. Cl. CPC A01G 25/023

(57) ABSTRACT

A clog resistant online vortex emitter assembly and method uses a double-sided circuit and a series of vortex chambers of optimized dimensions to create a pressure drop with large dimensions and good clog resistance. The vortex emitter allows for pressure regulation without moving parts and includes a unitary body having a first surface and a second surface opposite the first surface and a multi-lumen flow channel providing fluid communication between the first surface and the second surface, wherein said unitary body is a double-sided circuit with a plurality of vortex chambers with lumens aligned in series. The vortex chamber includes an inlet region, a power nozzle, an interaction region and a throat, the inlet region is in fluid communication with the interaction region through the power nozzle. The plurality of vortex chambers includes dimensions to create a pressure drop and be attached to an outer surface of an irrigation tube.

### CROSS-REFERENCE TO RELATED APPLICATIONS

This application is a continuation-in-part of U.S. Utility application Ser. No. 17/402,868 entitled “CLOG RESISTANT IN-LINE VORTEX ELEMENT IRRIGATION EMITTER,” filed on Aug. 16, 2021 which is a continuation of U.S. Utility application Ser. No. 16/001,432 entitled “CLOG RESISTANT IN-LINE VORTEX ELEMENT IRRIGATION EMITTER,” filed Jun. 6, 2018 (Now U.S. Pat. No. 1,111,615) which claims priority to and benefit of U.S. Provisional Application No. 62/515,973 entitled “CLOG RESISTANT IN-LINE VORTEX ELEMENT IRRIGATION EMITTER,” filed on Jun. 6, 2017, each of which are hereby incorporated by reference in their entireties

### FIELD OF THE DISCLOSURE

The present disclosure pertains generally to devices for use as drip irrigation emitters. More particularly, the present disclosure pertains to drip irrigation emitters that provide a substantially constant drip flow-rate over a wide range of line pressures. The present disclosure is particularly, but not exclusively, useful as a self-cleaning, pressure compensating, irrigation drip emitter optimized for assemblies having multiple irrigation drip emitters mounted to a supply tube to form an irrigation assembly or system.

### BACKGROUND

Drip emitters are commonly used in irrigation systems to convert water flowing through a supply tube at a relatively high pressure to a relatively low flow rate at the outlet of each emitter. Each drip emitter generally includes a housing defining a flow path that reduces high pressure water entering the drip emitter into relatively low pressure water exiting the drip emitter. Multiple drip emitters are commonly mounted on the inside or outside of a water supply tube. In one type of system, a large number of drip emitters are mounted at regular and predetermined intervals along the length of the supply tube to distribute water at precise points to surrounding land and vegetation. These emitters may either be mounted internally (i.e., in-line emitters) or externally (i.e., on-line or branch emitters).

It is desirable to provide an improved online drip emitter design. There is a need to provide for a relatively constant water output from each of the emitters in the irrigation system. More specifically, it is desirable to provide pressure compensation so as to ensure that the flow rate of the first emitter in the system is substantially the same as the last emitter in the system. Without such flow rate compensation, the last emitter in a series of emitters will experience a greater pressure loss than the first. Such pressure loss results in the inefficient and wasteful use of water.

Flow rate compensation has been offered in prior art drip irrigation assemblies (such as U.S. Pat. No. 4,226,368 (Hunter)) which discloses an assembly with multiple chambers or circuits providing interconnected vortices, but these assemblies often are subject to clogging and provide poor emitter efficiency.

Traditional prior art drip emitters containing moving parts and pressure compensating flexible membranes have one side of the membrane exposed to irrigation line pressure, while the opposite side of the membrane is exposed to a reduced pressure. For example, the reduced pressure can be created by forcing a portion of the water from the irrigation line through a restrictor or labyrinth. This pressure differential on opposite sides of the membrane causes the flexible membrane to deform. In particular, the higher line pressure can be used to force the flexible membrane into a slot where reduced pressure water is flowing. As the line pressure increases, the membrane will be pressed further into the slot, decreasing the effective cross-section of the slot and thus restricting flow through the slot. As described further below, the result is a relatively constant flow through the emitter over a range of line pressures. Unfortunately, the slot is subject to clogging in the same fashion as the simple orifice emitter. Further, the membrane is required to form a seal with the edge of the slot confining flow to the slot. Particulate buildup may also interfere with the membrane seal causing non-uniform flow. Clogging of an emitter can result in the dehydration of a plant and its eventual loss. Emitters are susceptible to clogging caused by chemical, external particles, dirt, and debris, which are common in irrigation water and, especially, surface water. Also, low water velocity and narrow and tortuous water paths inside the emitter assembly worsen the clog resistance of the emitter.

One attempt to solve the problems associated with particulate buildup in a pressure compensating emitter uses the reduced-pressure water from the labyrinth to clean the slot and sealing surfaces during initial pressurization of the irrigation line. In particular, such an emitter is disclosed by Miller in U.S. Pat. No. 5,628,462 which issued May 13, 1997, entitled “Drip Irrigation Emitter,” in which a chamber is created between the slot and the membrane. For the emitter disclosed by Miller, during initial pressurization of the irrigation line, while the membrane is only slightly deformed, the chamber is flushed with reduced-pressure water delivered from the restrictor or labyrinth. As the line pressure increases, the membrane deforms, sealing off the chamber from reduced pressure water, and restricting flow through the slot. Another attempt to solve the problems associated with particulate buildup involves total system filtration, disassembly of some of the non-PC emitters on the market, and wider and less restrictive flow paths. However, total system filtration is expensive and can be very high maintenance; disassembly and cleaning may only be possible for a certain subset of emitters, is otherwise time consuming, and risks the health of the plant when the assemblies are clogged or being cleaned so they are temporarily not operational; and, wider and less restrictive flow paths may result in an overall larger assembly.

An in-line vortex element irrigation emitter is disclosed by commonly owned U.S. patent Ser. No. 11/116,151 which discloses the use of a vortex chamber member on an in-line configuration of a drip emitter such as those disclosed by FIG. 1A. Such devices are manufactured by extruding the irrigation tube while installing the emitter device within the inner surface while being extruded. However, on-line emitter elements, as disclosed by FIG. 1B can be attached to the irrigation tube after the tube has been positioned in place to specifically target the outflow of fluid towards a desired target. On-line emitter elements provide flexibility for installation as they are added to the extruded tube usually at the job site.

The above cited prior art references are useful to set forth the nomenclature of drip emitter assemblies and components, and so are incorporated by reference in their entireties for that purpose and for enablement. The prior art drip emitters are not as effective and economical as is desired for use with an online emitter with an irrigation tube and there is a need for an economical, scalable, effective fluidic-equipped drip irrigation devices suitable for the purposes of providing a constant drip flow in response to a varying line pressure that reduces risk of clogging. There is a need for an improved clog-resistant online vortex emitter and drip irrigation assembly and method.

### SUMMARY

Accordingly, it is an object of the present disclosure to overcome the above mentioned difficulties by providing a clog resistant online vortex element irrigation emitter or irrigation dripper which is easy to use, relatively simple to manufacture, and comparatively cost effective to install, and over its life cycle. The online vortex emitter structure of the present disclosure may be designed to be injection molded as a component and then attached to the exterior of an extruded tube as part of a drip irrigation system. The drip irrigation assembly's tube may be placed in a farm field and fluid may be pumped in. The drip irrigation assembly may be used in vineyards, orchards, greenhouses and nurseries, home gardens, farms, and the like. The emitters take the high pressure and flow inside the tube and produce a desired flowrate (selectable depending on the requirements of the environment, terrain or plant being irrigated). The online vortex emitter of the present disclosure has a higher efficiency than traditional pivot or sprinkler systems. The online vortex emitter assembly not only provides the appropriate pressure attenuation; it resists clogging from the grit and debris in available ground water. Using emitters for irrigation can deliver water and nutrients to the root zone uniformly, prevent water loss via runoffs and evaporation, may be low maintenance compared to traditional watering methods, and may reduce weed, pests, and diseases by not watering unwanted areas.

In accordance with the present disclosure, a newly developed clog resistant online vortex element irrigation emitter gives a greater pressure attenuation for its physical dimensions than comparable devices in the prior art (as described above). The clog resistant online vortex emitter and drip irrigation assembly and method uses a double-sided circuit and a series of vortex chambers of optimized dimensions to create a pressure drop with large lumen dimensions and good clog resistance in an efficiently packaged sized housing. The large lumen dimensions and the vortex created in each chamber help flush debris and grit through the system. The circuit of the present disclosure is also optimized to take up the smallest space possible. The smaller circuit package along with the natural coring that occurs with the vortex circuit of the present disclosure saves on circuit mass. This saves irrigation assembly cost and allows grit to be flushed through the system while also efficiently reducing fluid pressure.

The vortex dimensions may be optimized for larger flow paths to allow larger particles through the assembly without clogging. The vortex circuit of the present disclosure is optimized for an emitter efficiency Ef value wherein Ef=(k/Ackt)*Amin such that k is a unitless head loss coefficient, Ackt is the area of the circuit, and Amin is the minimum cross-sectional area of the circuit. A higher k per given area with larger dimensions allows for an overall smaller emitter with a lower chance of clogging.

The vortex emitter circuit can be used with or without pressure compensating device or filter. Using a pressure compensating device allows a consistent flow rate regardless of input water pressure (as long as the water pressure is within the recommended operation range). On the other hand, the flow rate may not be adjusted by adjusting the incoming water pressure. The vortex emitter circuit may also include one or more of the following aspects: large flow paths to improve clog resistance, uniform flow rate, adjustable flow feature, take-apart feature for cleaning, self-cleaning (flushing/clog prevention) mechanism, no-drain mechanism, anti-suck-back (anti-siphon) mechanism, risers, anti-bug caps, and the like.

A filter component may be provided, such as a 3D filter, or filter positioned along an assembly housing, which may be used with the disclosed circuit to collect water from the bulk flow within the irrigation tube or pipe. The clog-resistant online vortex emitter of the present disclosure may sits along or above the bottom of the irrigation fluid tube or pipe which can see significant settling of debris and grit. The position of the filter may help remove grit through gravity. The vortex circuit may include large dimensions for a given pressure drop per area of circuit when compared with typical emitters. The large dimensions and the vortex created in each chamber help clear grit and debris from the system.

### BRIEF DESCRIPTION OF THE DRAWINGS

The operation of the present disclosure may be better understood by reference to the following detailed description taken in connection with the following illustrations, wherein:

FIG. 1A is an illustration of an embodiment of an in-line emitter assembly of the prior art;

FIG. 1B is an illustration of an embodiment of an online emitter assembly of the prior art;

FIG. 2 is a top perspective view of an embodiment of an online vortex emitter having a plurality of vortex emitter chambers in accordance with the present disclosure;

FIG. 3 is a bottom perspective view of an embodiment of an online vortex emitter having a plurality of vortex emitter chambers in accordance with the present disclosure;

FIG. 4 is a top view, in elevation, of a single vortex emitter chamber of FIGS. 2-3 in accordance with the present disclosure;

FIG. 5 is a side view, in elevation, of the vortex emitter chamber of FIGS. 2-3, in accordance with the present disclosure; and

FIG. 6 is a top perspective view of an embodiment of an online vortex emitter and assembly thereof in an irrigation system.

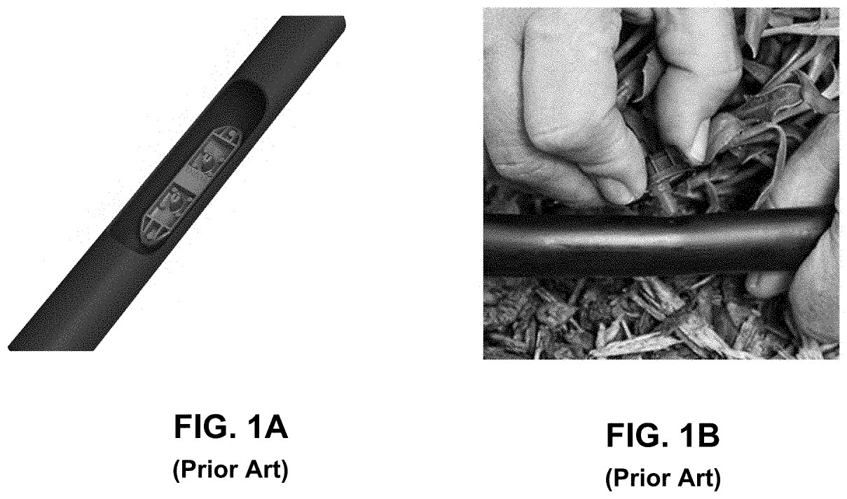

### DETAILED DESCRIPTION

Reference will now be made in detail to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments.

As used herein, the words “example” and “exemplary” mean an instance, or illustration. The words “example” or “exemplary” do not indicate a key or preferred aspect or embodiment. The word “or” is intended to be inclusive rather than exclusive unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Similar reference numerals are used throughout the figures. Therefore, in certain views, only selected elements are indicated even though the features of the system or assembly may be identical in all of the figures. In the same manner, while a particular aspect of the disclosure is illustrated in these figures, other aspects and arrangements are possible, as will be explained below.

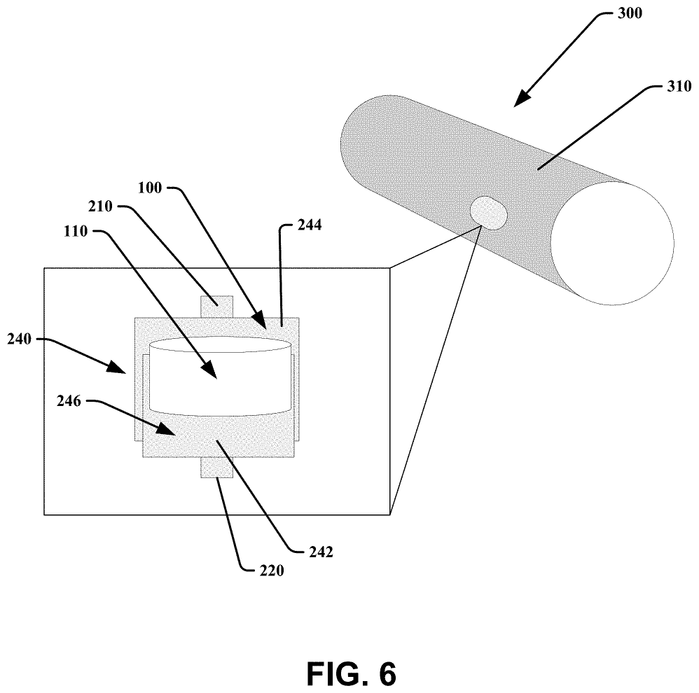

Provided is an embodiment of a clog resistant online vortex irrigation emitter assembly 100 and its components parts. As shown in FIG. 6, in one embodiment, the vortex emitter assembly 100 includes a vortex emitter circuit 110 wherein the assembly defines an inlet 210, an outlet 220, and a flow channel therebetween providing fluid communication between the inlet 210 and the outlet 220. The vortex emitter assembly 100 comprising the vortex emitter circuit 110 may be positioned or attached to the exterior 310 of an extruded tube 300. Although the shape of the vortex emitter assembly 100 is generally illustrated as a rectangular shape, the vortex emitter assembly 100 may also be circular, spherical, etc. so that it may attach to the tube 300.

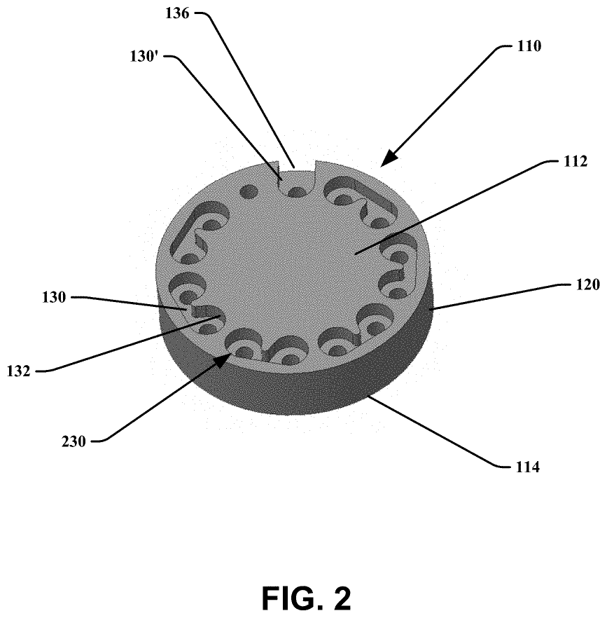

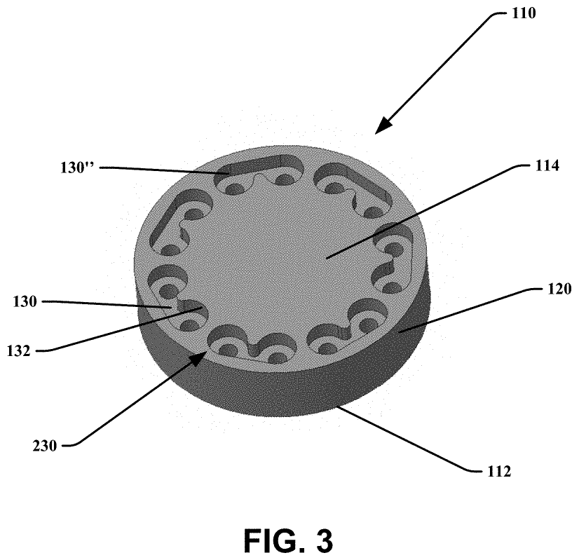

FIGS. 2 and 3 illustrate an embodiment of the vortex emitter circuit 110 that may be defined to include a unitary body 120 with a double-sided surface 112, 114 having a plurality of single or individual vortex chambers 130 with flow channel lumen dimensions optimized to create a pressure drop with large lumen dimensions and good clog resistance. The vortex chambers may be arranged into a circular form so they fit into online emitter housings or frames for PC and NON-PC online vortex emitters.

FIG. 6 illustrates that the vortex emitter circuit 110 is positioned within a housing 240 having a first portion 242 and a second portion 244 that define a cavity 246 therein. The body 120 of the circuit 110 is positioned within the cavity to allow for the vortex emitter circuit 110 to be in fluid communication between the inlet 210 and the outlet 220. The first and second portions 242, 244 of the housing 240 may be attached to or detached from one another to allow the vortex emitter circuit 110 to be placed security within the cavity or disassembled from the cavity 246. This allows for quick cleaning of the assembly when needed.

The vortex circuit 110 and the size and shape of the vortex chambers 130 of the present disclosure may be optimized for a dimensionless coefficient of emitter efficiency “Ef” wherein “Ef=(k/Ackt)*Amin.” In this equation, k is a unitless head loss coefficient, Ackt is the total area of the circuit, and Amin is the minimum cross-sectional area of the circuit. This measurement identifies if there is a relatively large head loss per unit area of the emitter assembly while achieving relatively good clog resistance to grit within the fluid.

The vortex emitter circuit 110 may further include various sections such as a filter component and a pressure compensating component (not shown). Using a pressure compensating device allows a consistent flow rate regardless of input water pressure (as long as the water pressure is within the recommended operation range). On the other hand, the flow rate may not be adjusted by adjusting the incoming water pressure. The filter component may be any structural configuration that allows fluid to flow therethrough that may catch debris or other particulate prior to flowing through the assembly 100 and the circuit 110. The filter component may have various structural configurations and may function to allow fluid to pass through an inlet of the assembly 100 while preventing relatively large grit or particulates located within the pressurized fluid flowing though the tube from entering the assembly 100. The pressure compensating component may be a moveable device that modifies the pressure and flow of fluid through the assembly 100 in a particular manner in an effort to manage pressure of fluid flow therein. The pressure compensating component may include a gasket or diaphragm. The vortex emitter circuit 110 may also include one or more of the following aspects: large flow paths to improve clog resistance, uniform flow rate, adjustable flow feature, take-apart feature for cleaning, self-cleaning (flushing/clog prevention) mechanism, no-drain mechanism, anti-suck-back (anti-siphon) mechanism, risers, anti-bug caps, and the like.

The vortex emitter circuit 110 may include a pressure reducing component 230 that includes a plurality of vortex chambers 130. The vortex chambers may be rearranged into a circular form so they fit into online emitter frames for PC and NON-PC online vortex emitters. The vortex mechanism may improve grit suspension and lead to better clog resistance. Each vortex chamber 130 may defined by a wall 132 defining a fluid passageway and be aligned in an interconnecting pattern along a first surface 112 of the vortex emitter circuit 110 as well as a second opposite surface 114 of the vortex emitter circuit 110. As illustrated by FIG. 3, each vortex chamber 130 includes an inlet region 140, a power nozzle 150, and an interaction region 160 with an outlet 170. The vortex emitter circuit 110 may generally include one inlet and one or more outlets, such that the vortex emitter circuit 110 could be used in multi-port emitters. The inlet of the vortex emitter circuit 110 may be varied for different types of connections of the vortex emitter circuit 110 or assembly to the line 300, including self-piercing or male and female threading.

The inlet region 140 may include an inlet orifice 180 that is in communication with a different vortex chamber 130 aligned in series within the circuit 110. The outlet may be in communication with a different vortex chamber 130 aligned in series within the circuit 110. The inlet region 140 may be rounded about the inlet orifice 180 (if present) and be in fluid communication with the interaction region 160 through the power nozzle 150.

A convergence angle CA may be measured from an apex 152 aligned along the wall 132 about the perimeter of the vortex chamber 130 at the power nozzle 150. The convergence angle CA includes a first side that extends from the wall 132 at the apex 152 along the inlet region 140 and a second side that extends from the wall 132 at an opposite side of the apex 152 along a generally straight line aligned with the inlet region 140, power nozzle 150 and interaction region 160 as illustrated by FIG. 3. The convergent angle CA may be a minimum angle of 45° but may be up to about 80°. In one embodiment, the convergent angle CA may be about 55°. If the convergence angle CA is too small and the pressure drop decreases while the area increases, this may decrease the emitter efficiency Ef value. If the convergent angle CA exceeds 80°, the flow conditioning may be such that the vorticity is reduced thereby reducing k more than Ackt, resulting in lower Ef values.

Further, the convergence angle CA may be modified to change the overall length of each vortex chamber 130. When arranging a plurality of vortex chambers 130 together in series, the convergence angle CA may be configured to allow for the closest possible spacing that manufacturing processes may allow. These processes may include molding but may also include others such as additive manufacturing or the like. The desired placement of vortex chambers 130 in an efficient use of space along the surfaces 112, 114 may increase the emitter efficiency Ef value of the assembly 100.

The power nozzle 150 may include a width Pw and a radius Pr. The dimension of the power nozzle radius Pr is desirable to be smaller to maintain a high velocity of fluid flow through the power nozzle 150. In one embodiment, this dimension may be as small as manufacturing constraints permit, such as between about 0.05 mm to about 0.3 mm or, in one embodiment, 0.07 mm. The power nozzle width Pw may be a minimum of 0.8 mm to avoid clogging. The configuration of the vortex chambers 130 may depend on the dimensions of the power nozzle 150 and incorporate ratios relative to the power nozzle width Pw. The outlet 170 (as well as the inlet 180) may include a throat diameter Td wherein the throat diameter Td may be at least 0.8 mm, but it is desired not to be much larger as otherwise vorticity may be reduced. The interaction region 160 includes an interaction region diameter IRD. In one embodiment the ratio of the throat diameter Td to the power nozzle width Pw may be about 1:1 additionally, the minimum interaction region diameter IRD to power nozzle width Pw ratio may be about 2:1 and the minimum interaction region diameter IRD to throat diameter Td ratio may also be about 2:1. In one embodiment, the interaction region diameter IRD to throat diameter Td ratio may be about 2.69:1 and include a range of 2.69+/−1.2 to 1.

The interaction region diameter IRD may be designed to be small enough that the area is reduced, but large enough the circuit 130 and fluid flowing therein creates a vortex in the interaction region 160. In one embodiment, the ratio for the dimension of the interaction region diameter IRD relative to the power nozzle width Pw is about 2.15:1 IRD:Pw. The range of this ratio may be 2.15 from about minus 0.15 to about plus 0.85 to 1.

The inlet region 140 may include an exit diameter ED. The exit diameter ED may be the same size as the interaction region diameter IRD. It may cause a small pressure drop as the flow goes from the inlet to the expanded area within the inlet region 140. A large exit diameter ED may allow the vortex chamber 130 to include a large convergence angle CA going into the subsequent vortex chamber 130 which may assist to keep the flow conditioning going into the vortex chambers 130.

In one embodiment, provided is an outlet vortex chamber 130′, of a plurality of vortex chambers 130, that is aligned in direct communication with an assembly outlet 220 or a pressure compensating component may not include an outlet 170 positioned through the unitary body 120 of the circuit 110 but otherwise may include a passage 136 in direct communication with the pressure compensating component or assembly outlet. Similarly, if the vortex chamber is in communication with an assembly inlet (such as a pressure compensating component or filter component), the inlet region 140 may not include an inlet orifice 180 but otherwise include a passage in direct communication with the pressure compensating component or filter component. In this embodiment, fluid is configured to flow through the inlet 210 of the housing 240 and be directed towards an initial or inlet vortex chamber 130″ along the second surface of the body 130. Fluid then flows in series though the plurality of vortex chambers 130 along both the first and second surfaces until reaching the outlet vortex chamber 130′. Fluid may be prevented from leaving the cavity 246 due to the configuration of the first and second portions of the housing 240 that abut against the body 120 to form the continuous fluid passage defined by the plurality of vortex chambers 130 in series along the first and second surfaces 112, 114. The fluid then is configured to exit the outlet through the outlet vortex chamber 130′.

The first surface 112 of the unitary body 120 may be formed into a generally circle shape wherein the plurality of vortex chambers 130 are positioned adjacent to one another along an outer perimeter of the first surface. The second surface 114 of the unitary body 120 may be formed into a generally circle shape wherein the plurality of vortex chambers 130 are positioned adjacent to one another along an outer perimeter of the second surface. The unitary body 120 may take on a generally cylindrical configuration having the first and second surfaces 112, 114 positioned generally parallel relative to one another and to allow the body 120 to be inserted within the housing 240.

In one embodiment, the first surface 112 includes at least seven vortex chambers 130 aligned along the surface having the elongated shaped portion facing a perimeter edge of the unitary body 120. In another embodiment, the second surface 114 may include at least eight vortex chambers 130 having an elongated shaped portion of the chamber facing a perimeter edge of the unitary body 120. In these configurations the apices 152 of each of the vortex chambers 130 are positioned radially inwardly from power nozzles 150 relative to the perimeter edges of the first and second surfaces, respectively.

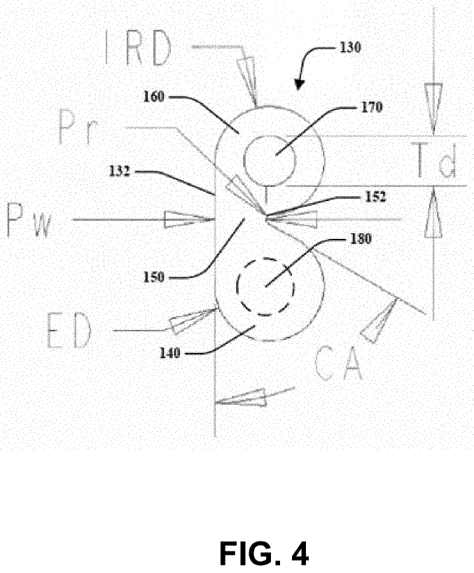

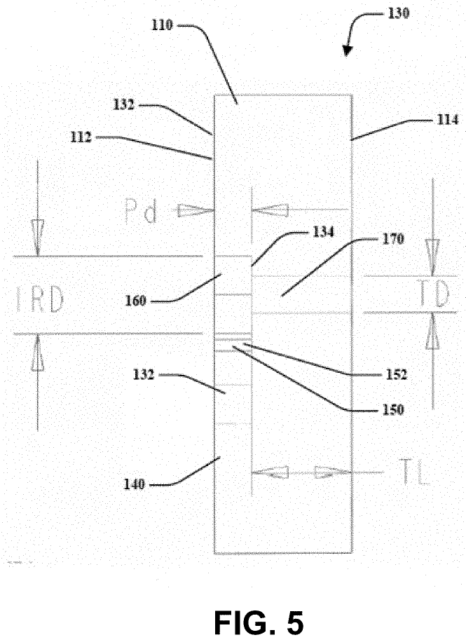

FIG. 5 illustrates a side view, in elevation, of the vortex emitter chamber 130 of FIG. 4, in accordance with the present disclosure. The power nozzle 150 includes a depth Pd that extends from a surface 132 of the circuit to a floor 134 of the circuit 110. In one embodiment, the circuit 110 may adopt the depth Pd of the power nozzle 150 to be about equal to the depth of the other component parts including the interaction region 160 and the inlet region 140. This configuration may provide a smooth transition of fluid flow from power nozzle 150 to interaction region 160. However, the depth of each component part may be varied, and this disclosure is not limited in this regard. In one embodiment, the power nozzle depth Pd may also be equal to the power nozzle width Pw. The ratio of the power nozzle width Pw to the power nozzle depth Pd may be about 1:1 but may be in the range of 1+/−0.25 to 1. The power nozzle 150 may include a cross sectional shape formed into a square which may provide preferred flow conditioning into the interaction region 160 and may provide a preferred minimum dimension for the area of the power nozzle 150. Also illustrated is a throat length TL that extends from the floor 134 of the vortex chamber 130 to an opposing side of the circuit 110 which may be connected to another vortex chamber 130 positioned along the second side 114 of the circuit 110 described herein or may be a further pattern to allow for the fluid flow to communicate with either a filter component, a pressure compensating component, or an outlet/nozzle to spray fluid to environment.

The vortex emitter assembly 100 of the present disclosure works by taking the flow of fluid and passing it through a converging passage defined by a series of vortex chambers 130 aligned in series along either side of the circuit 110. The circuit 110 includes a unitary body having opposing sides of particular chambers having particular geometric configuration to condition the flow of water or fluid therethrough. This configuration has been found to increase the velocity of the flow and condition it to produce a better spin or vorticity. It has been found that the larger the power nozzle's initial linear velocity, the larger the interaction regions rotational or angular velocity. The larger the angular velocity, the larger the head loss Kl. This loss is due to the dissipation of kinetic energy by shear stress occurring between layers of rotating fluid. The number of vortex chambers 130 positioned in a circular configuration, the dimensions of the convergence angle CA, the power nozzle width PW, the interaction region diameter IRD and the throat diameter Td have been identified to optimize pressure drop through the circuit 100. A series of design experiments were conducted to identify the optimal values and ratios of these dimensions wherein the ratios were identified to maintain optimal emitter efficiency Ef.

The more efficient the circuit can turn linear flow in to rotational flow, the larger the pressure drop. The convergence angle CA should be somewhere between 45° to 70° or 80°. Between these angles, the k value used to calculate the emitter efficiency Ef does not change a great deal. The spatial efficiency of the circuit, the aim of the flow, and conditioning are all affected by the convergence angle CA. The convergence angle CA and interaction region diameter IRD may affect the overall circuit length as it may be desirable to place a plurality of vortex chambers 130 along a surface of the circuit 110 in close proximity to one another. In one embodiment, it may be desirable to fit the largest number of vortex chambers 130 allowable on the circuit 110. In this embodiment, the convergence angle CA may be sufficiently large enough that the total length of the vortex chamber 130 is short. The spacing between chambers 130 may be set by the length of each chamber 130 so the angle may be as large as possible without placing the chambers 130 too close to each other.

The convergence angle CA may be large enough so that the aim and conditioning are such that the greatest pressure attenuation for the package size may be achieved. Small angles (below 45°) and large angles (80°) may reduce the pressure attenuation of the circuit. Small angles may not aim the flow enough towards the wall of the vortex chamber 130 and away from the power nozzle 150 and throat 170. Small angles also may have a much larger footprint decreasing the emitter efficiency Ef value. Large angled may slow the flow down and force it too much to the outside and the vortex may not be as powerful.

The inlet region 140 may converge towards the power nozzle 150 along the chamber walls 132 defined by the convergence angle CA. The power nozzle 150 may have the same depth as width (Pw=Pd). A square power nozzle may provide the largest minimum dimension for the area and has better flow conditioning. A power nozzle width Pw that is larger makes it harder to avoid losing vorticity as the flow may be directed straight into the throat. A power nozzle width Pw that is smaller may affect the flow conditioning going into the chamber 130, reducing its efficiency. In one embodiment, the power nozzle 150 may have no straight length to it. Having a large convergence angle CA may allow for a corresponding large region on the exit of the throat 170. The sudden expansion may have a small, but not insignificant pressure drop. One wall of the converging angle CA meets with the interaction region 160 tangentially at the power nozzle 150. The other side of the power nozzle 150 is a round apex 152 where the convergent angle CA and the interaction region 160 meet. This round portion or apex 152 may be as small as manufacturing processes constraints such as molding or additive manufacturing may allow as a small apex 152 may provide a higher velocity and give improved system performance.

The inlet region 140 may be considered a converging passage that communicates with the interaction region 160 which may be a circular chamber with a hole or throat 170 in the center. The converging passage aims the flow of the circuit 130 mostly tangentially with some aim towards the wall 132 to create a vortex in the interaction region 160 that creates pressure attenuation by dissipating energy through the angular momentum of the vortex flow created by the geometry of the chamber walls 132. This configuration may also be responsible for the pressure regulation. As the pressure increases, the loss of pressure due to the angular momentum increases and reduces the measured exponent of the circuit 110. The interaction region diameter IRD to power nozzle width Pw may be about 2:1 to 3:1 but more specifically may be about 2.15:1.

If the interaction region diameter IRD were smaller than about (2:1) the vorticity may be lost, and a larger ratio than about (3:1) may make the area increase at a faster rate than the pressure drop. The small circuit size may be space efficient and allow a larger number of vortex chambers 130 to be configured in a small package. The throat 170 may be a minimum dimension of 0.8 mm in diameter to avoid clogging. It may be small enough that the flow doesn't directly enter the throat 170 lowering the vorticity of the circuit 110.

As noted above, the vortex emitter assembly 100 and/or circuit 110 of the present disclosure may be created as an injection molded component. It may be static, with no moving parts or may be dynamic, having a pressure compensating device to assist with pressure manipulation. The drip irrigation assembly's tube 300 may be placed in a farm field and water may be pumped in. The drip irrigation assembly may be used in vineyards, orchards, greenhouses and nurseries, home gardens, farms, and the like. The emitter assemblies 100 may take the high-pressure flow inside the tube and produce a desired flowrate (selectable depending on the requirements of the environment, terrain or plant being irrigated).

The vortex emitter assembly 100 of the present disclosure and the disclosed pressure reducing elements may provide a higher efficiency than traditional pivot or sprinkler systems. The emitters 100 may not only provide the appropriate pressure attenuation; they may resist clogging from the grit and debris in available ground water. In accordance with the present disclosure, newly developed prototype clog resistant online vortex element irrigation emitter may give a greater pressure attenuation for its physical dimensions than comparable devices in the prior art (as described above). The large dimensions and the vortex created in each chamber 130 help flush debris and grit through the system. The smaller circuit package along with the natural coring that occurs with the vortex circuit of the present disclosure saves on circuit size. This saves irrigation assembly cost.

While in accordance with the patent statutes the best mode and certain embodiments of the disclosure have been set forth, the scope of the disclosure is not limited thereto, but rather by the scope of the attached. As such, other variants within the spirit and scope of this disclosure are possible and will present themselves to those skilled in the art.

Although the present embodiments have been illustrated in the accompanying drawings and described in the foregoing detailed description, it is to be understood that the vortex emitter assemblies are not to be limited to just the embodiments disclosed, but that the systems and assemblies described herein are capable of numerous rearrangements, modifications, and substitutions. The exemplary embodiment has been described with reference to the preferred embodiments. Obviously, modifications and alterations will occur to others upon reading and understanding the preceding detailed description. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An online vortex emitter assembly for an irrigation tube comprising:
a housing that defines a cavity that includes an inlet and an outlet, the cavity configured to allow fluid to flow between the inlet and the outlet;
a unitary body having a first surface and a second surface opposite the first surface and a multi-lumen flow channel therebetween providing fluid communication between the first surface and the second surface, wherein said unitary body is configured as a double-sided circuit and a plurality of vortex chambers with lumens aligned in series;
each vortex chamber of said plurality of vortex chambers includes an inlet region, a power nozzle, an interaction region and a throat, the inlet region is in fluid communication with the interaction region through the power nozzle, the power nozzle is defined by an opposite wall that extends between the inlet region and the interaction region and an apex; and
a convergence angle defined by a perimeter wall of each said vortex chamber that extends from the apex of the power nozzle along the inlet region and the opposite wall along the inlet region, wherein said convergence angle is between about 45° to about 80° such that the inlet region has a different shape than the interaction region along the convergence angle;
wherein said plurality of vortex chambers include dimensions to create a pressure drop of fluid flow and wherein the inlet of the housing is configured to be attached to an outer surface of an irrigation tube.

2. The online vortex emitter assembly of claim 1, wherein the first surface includes at least seven vortex chambers.

3. The online vortex emitter assembly of claim 1, wherein the second surface includes at least eight vortex chambers.

4. The online vortex emitter assembly of claim 1, wherein the first surface of the unitary body is formed into a generally circle shape and wherein the plurality of vortex chambers are positioned adjacent to one another along an outer perimeter of the first surface.

5. The online vortex emitter assembly of claim 1, wherein the second surface of the unitary body is formed into a generally circle shape and wherein the plurality of vortex chambers are positioned adjacent to one another along an outer perimeter of the second surface.

6. An online irrigation tube system comprising at least one vortex emitter assembly of claim 1, further comprising a tube having an outer surface wherein a plurality of vortex emitter assemblies are positioned along said outer surface of said tube.

7. The online vortex emitter assembly of claim 1, wherein said convergence angle is about 55°.

8. The online vortex emitter assembly of claim 1 wherein said power nozzle includes a width (Pw) wherein the width has a minimum dimension of about 0.8 mm and a radius (Pr) wherein the radius is between about 0.05 mm to about 0.3 mm

9. The online vortex emitter assembly of claim 1 wherein said interaction region includes a diameter (IRD) and the power nozzle includes a width (Pw) wherein said interaction region diameter (IRD) includes a ratio with said power nozzle width (Pw) that is in the range of about 2:1 to about 3:1.

10. The online vortex emitter assembly of claim 9 wherein said ratio between said interaction region diameter (IRD) and said power nozzle width (Pd) is about 2.15:1.

11. The online vortex emitter assembly of claim 9, wherein said ratio between said interaction region diameter (IRD) and said throat diameter (Td) is about 2.69:1.

12. The online vortex emitter assembly of claim 9, wherein said power nozzle includes a width (Pw) and a depth (Pd), and wherein said power nozzle width (Pw) includes a ratio with said power nozzle depth (Pd) that is in the range of about 0.75:1 to about 1.25:1.

13. The online vortex emitter assembly of claim 1, wherein said interaction region includes a diameter (IRD) and the throat includes a diameter (Td), and wherein said interaction region diameter (IRD) includes a ratio with said throat diameter (Td) that is in the range of about 1.49:1 to about 3.89:1.

14. The online vortex emitter assembly of claim 1 wherein the apex of each of the plurality of vortex chambers are positioned radially inwardly from power nozzles relative to a perimeter edge of the first surface.

15. An online vortex emitter assembly for an irrigation tube comprising:
a housing that defines a cavity that includes an inlet and an outlet, the cavity configured to allow fluid to flow between the inlet and the outlet;
a unitary body having a first surface and a second surface opposite the first surface and a multi-lumen flow channel therebetween providing fluid communication between the first surface and the second surface, wherein said unitary body is configured as a double-sided circuit and a plurality of vortex chambers with lumens aligned in series, wherein the first surface of the unitary body is formed into a generally circle shape and wherein the plurality of vortex chambers are positioned adjacent to one another along an outer perimeter of the first surface and wherein the second surface of the unitary body is formed into a generally circle shape and wherein the plurality of vortex chambers are positioned adjacent to one another along an outer perimeter of the second surface;
at least one vortex chamber of said plurality of vortex chambers includes an inlet region, a power nozzle, an interaction region and a throat, the inlet region is in fluid communication with the interaction region through the power nozzle, the power nozzle is defined by an opposite wall that extends between the inlet region and the interaction region and an apex; and
a convergence angle defined by a perimeter wall of each said vortex chamber that extends from the apex of the power nozzle along the inlet region and the opposite wall along the inlet region, wherein said convergence angle is between about 45° to about 80° such that the inlet region has a different shape than the interaction region along the convergence angle;
wherein said plurality of vortex chambers include dimensions to create a pressure drop of fluid flow and wherein the inlet of the housing is configured to be attached to an outer surface of an irrigation tube.

16. The online vortex emitter assembly of claim 15, wherein the first surface includes at least seven vortex chambers.

17. The online vortex emitter assembly of claim 15, wherein the second surface includes at least eight vortex chambers.

18. The online vortex emitter assembly of claim 15 wherein the apex of each of the plurality of vortex chambers are positioned radially inwardly from power nozzles relative to a perimeter edge of the first surface.
